(19) United States
(12) Patent Application Publication
(10) Pub. No.: US 2025/0156064 A1
(43) Pub. Date: May 15, 2025

(54) INFORMATION PROCESSING DEVICE AND NON-TRANSITORY, COMPUTER-READABLE RECORDING MEDIUM THEREFOR

(71) Applicant: Faurecia Clarion Electronics Co., Ltd., Saitama-shi (JP)

(72) Inventors: Takuma SHIOGUCHI, Saitama (JP); Keiichiro YOSHIHARA, Saitama (JP); Kenta YASUTOMO, Saitama (JP); Jun KAWANO, Saitama (JP); Takahiro UEMURA, Saitama (JP)

(21) Appl. No.: 18/926,558

(22) Filed: Oct. 25, 2024

(30) Foreign Application Priority Data
Nov. 9, 2023 (JP) 2023-191334

(51) Int. Cl. G06F 3/0488; B60K 35/22; B60K 35/28; G06F 3/0482; G06F 3/0486

(52) U.S. Cl. CPC G06F 3/0488; B60K 35/22; B60K 35/28; G06F 3/0482; G06F 3/0486; B60K 2360/1438

(57) ABSTRACT

An information processing device is a device connected to a touch operable display device, and includes a detection unit that detects the position of an operator relative to the screen of the display device, and a display control unit that repositions operable objects displayed on the screen so as to be closer to the position of the operator detected by the detection unit, and displays the objects on the screen.

### TECHNICAL FIELD

The present disclosure relates to an information processing device and to a computer program.

### BACKGROUND

Display devices having large screens have come into practical use. For example, Patent Document 1 describes an information processing device that performs display control of this type of display device.

The information processing device described in Patent Document 1 changes the display range of an image in a screen region that displays the same image as that displayed in an electronic side mirror in response to a touch operation on the screen of a display device installed inside a vehicle cabin.
Patent Document 1: Japanese Unexamined Patent Application Publication 2022-11370

### SUMMARY

In Patent Document 1, the screen of the display device is sized to cover almost the entire dashboard. Therefore, for example, a driver sitting in the driver seat may have difficulty touching and operating an object displayed in the region of the screen close to the passenger seat because the finger of the driver cannot reach the object. As described above, there is room for improvement in Patent Document 1 in terms of improving the operability of touch operations on objects displayed in a screen region away from the operator.

In consideration of the forgoing, an aspect of the present disclosure aims to provide an information processing device and a computer program that can improve the operability of a touch operation on objects displayed in a screen region away from the operator.

An information processing device according to one aspect of the present disclosure is a device connected to a touch operable display device, and includes a detection unit that detects the position of an operator relative to the screen of the display device, and a display control unit that repositions operable objects displayed on the screen so as to be closer to the position of the operator detected by the detection unit, and displays the objects on the screen.

According to an embodiment of the present disclosure, an information processing device and a computer program are provided that can improve the operability of a touch operation on an object displayed in a screen region away from an operator.

### BRIEF DESCRIPTION OF THE DRAWINGS

FIG. 1 is a diagram schematically depicting a vehicle in which an in-vehicle system is installed according to an embodiment of the present disclosure;

FIG. 2 is a block diagram depicting a hardware configuration of an in-vehicle system according to an embodiment of the present disclosure;

FIG. 3 is a diagram depicting an example of a display screen displayed on a screen of a display unit according to an embodiment of the present disclosure;

FIG. 4 is a diagram depicting an example of a display screen when a touch operation is performed on the screen depicted in FIG. 3;

FIG. 5 is a diagram depicting an example of a display screen when a touch operation is performed on the screen depicted in FIG. 3;

FIG. 6 is a diagram depicting an example of a display screen when a touch operation is performed on the screen depicted in FIG. 5;

FIG. 7 is a diagram depicting an example of a display screen when the operator is a passenger;

FIG. 8 is a flowchart depicting a process executed by a control unit included in the in-vehicle system according to an embodiment of the present disclosure;

FIG. 9 is a subroutine of the first main process (step S104) in FIG. 8; and

FIG. 10 is a subroutine of the second main process (step S105) in FIG. 8.

### DETAILED DESCRIPTION OF EMBODIMENTS

The following description relates to an information processing device and a computer program stored on a non-transitory, computer-readable recording medium according to an embodiment of the present disclosure. Note that common or corresponding elements are marked with the same or similar reference codes, and duplicate descriptions are simplified or omitted as appropriate.

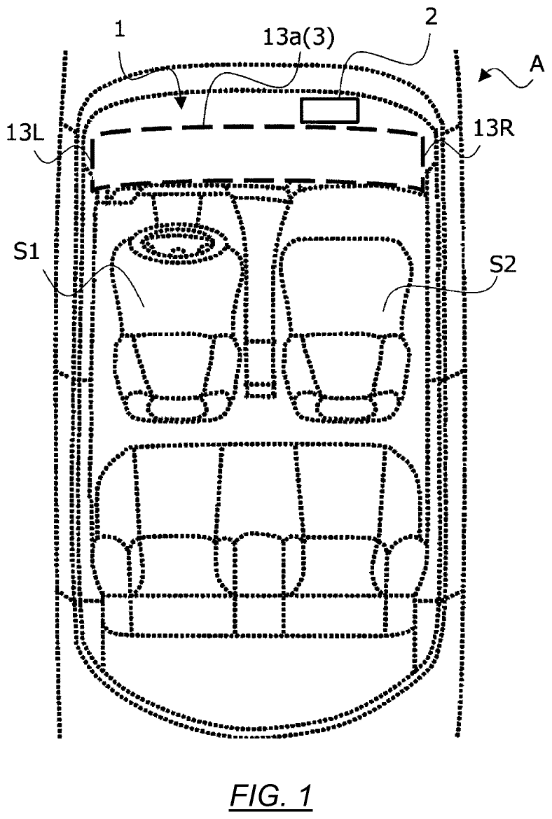

FIG. 1 is a diagram schematically depicting a vehicle A in which is installed an in-vehicle system 1 according to an embodiment of the present disclosure. Vehicle A is an example of a moving body, and is a left-hand drive vehicle. Vehicle A may be a right-hand drive vehicle.

The in-vehicle system 1 includes, for example, a main unit 2 installed in a dashboard and a display unit 13 connected to the main unit 2. The screen 13a of the display unit 13 is sized to extend from close to the right front pillar to close to the left front pillar. The symbol 13R designates the right edge of the screen 13a located close to the right front pillar. The symbol 13L designates the left edge of the screen 13a located close to the left front pillar.

In this manner, the display unit 13, which is an example of a display device, is installed inside the vehicle A. A row of seats is installed inside vehicle A, including a driver seat S1 and a passenger seat S2 (an example of a left seat and a right seat aligned in the same row, and an example of a first seat and a second seat aligned in a first direction). The screen 13a of the display unit 13 is positioned in front of the row of seats and is formed to extend in the vehicle width direction of the vehicle A.

It should be noted that, as used in this disclosure, any reference to an element using a designation such as “first”, “second”, and the like does not generally limit the quantity or order of those elements. These designations are used for convenience to distinguish between two or more elements. Thus, reference to a first and second element does not imply that only two elements are used, or that the first element must precede the second element, for example.

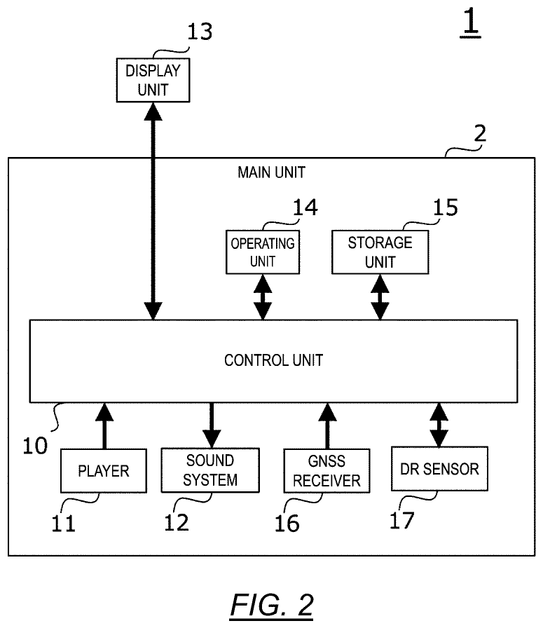

FIG. 2 is a block diagram depicting a hardware configuration of an in-vehicle system 1 according to an embodiment of the present disclosure. The in-vehicle system 1 includes a main unit 2 (an example of an information processing device) connected to a touch-operable display device (display unit 13 in the present embodiment). The in-vehicle system 1 is equipped with various functions including, for example, an audio function and a navigation function. The in-vehicle system 1 may be a device that is a portion of an IVI (In-Vehicle Infotainment) system.

As depicted in FIG. 2, the main unit 2 includes a control unit 10, a player 11, a sound system 12, an operating unit 14, a storage unit 15, a Global Navigation Satellite System (GNSS) receiver 16, and a Dead Reckoning (DR) sensor 17.

The main unit 2 may be configured to include only a portion of structural elements (for example, the control unit 10 and the storage unit 15). In this case, other structural elements (such as the player 11) that are not included in the main unit 2 may be configured as units that are independent of the main unit 2. In addition, the main unit 2 may be configured as a single vehicle-mounted device that includes a display unit 13 in addition to the control unit 10, player 11, sound system 12, operating unit 14, storage unit 15, GNSS receiver 16, and DR sensor 17.

Furthermore, the in-vehicle system 1 may include other components not depicted in FIG. 1. In other words, there is a degree of freedom in the configuration of the in-vehicle system 1 and the main unit 2, and various design changes are possible.

The player 11 is connected to an audio source. The player 11 plays an audio signal input from the audio source, which is then output to the control unit 10.

Examples of audio sources include disk media such as CDs (Compact Discs), SACDs (Super Audio CDs), and the like, that store digital audio data, as well as storage media such as HDD (Hard Disk Drive), USB (Universal Serial Bus), and the like, and smartphones, tablet terminals, and servers that stream data via a network. When the audio source is distributed by streaming or when the audio source is stored in the storage unit 15 described later, the player 11 as separate hardware may be omitted.

The main unit 2 including the control unit 10 and the storage unit 15 is an example of an information processing device according to an embodiment of the present disclosure, and is an example of a computer that executed the information processing method and information processing program according to the present embodiment.

The control unit 10 is configured, for example, as an LSI (Large Scale Integration) and includes a CPU (Central Processing Unit), a RAM (Random Access Memory), a ROM (Read-Only Memory), and a DSP (Digital Signal Processor).

In this manner, the information processing device according to the present embodiment is incorporated into the in-vehicle system 1 as the main unit 2 including the control unit 10 and the storage unit 15.

The control unit 10 executes various programs deployed in a working area of the RAM. As a result, the control unit 10 controls the operation of the in-vehicle system 1.

The control unit 10 is a single processor or a multiprocessor, for example, and includes at least one processor. When configured to include a plurality of processors, the control unit 10 may be packaged as a single device, or may be configured as a plurality of devices that are physically separated within the in-vehicle system 1.

The control unit 10 processes digital audio signals input from the player 11 or the storage unit 15, and outputs the processed signals to the sound system 12.

The sound system 12 includes a D/A converter, amplifier, and the like. The digital audio signal is converted into an analog signal by a D/A converter. The analog signal is amplified by an amplifier, and output to each speaker installed in the vehicle cabin. Thereby, music, for example, recorded on a audio source is played from each speaker inside the vehicle.

The display unit 13 is a device that displays various screens, and includes, for example, a display configured with an LCD (Liquid Crystal Display) or an organic EL (Electro Luminescence). The display is equipped with a touch panel.

A user (operator) can perform various touch operations on the display (screen 13a), such as touch on (touching screen 13a with a finger), touch off (removing a finger from screen 13a), flick (flicking a finger across screen 13a), swipe (slide), drag, and drop.

The control unit 10 detects the coordinates on the screen 13a that are touched, and executes a process associated with the detected coordinates.

In other words, the display unit 13 is an example of a touch-operable display device. Additionally, the control unit 10 is connected to a display unit 13 which is an example of a display device.

The operating unit 14 includes mechanical operators such as mechanical, capacitive non-contact, and membrane switches, buttons, knobs, wheels, and the like. The display unit 13 equipped with a touch panel display constitutes a portion of the operating unit 14. A GUI on which touch-operable controls are arranged is displayed on a screen 13a of the display unit 13.

An operator can operate the in-vehicle system 1 via mechanical controls or controls on the GUI (Graphical User Interface).

The storage unit 15 is, for example, an auxiliary storage device such as a hard disk drive (HDD) or a solid-state drive (SSD), or a flash memory. The storage unit 15 stores various programs, such as an information processing program for executing the information processing method according to the present embodiment, various data such as map data for navigation, and the like. In one example, the storage unit 15 includes a non-transitory, computer-readable recording medium having a computer program stored thereon that can be executed by an electronic processor of the information processing device. If the player 11 is omitted, the audio source data is also stored in the storage unit 15.

The GNSS receiver 16 measures the current position of the vehicle based on GNSS signals received from a plurality of GNSS satellites. The GNSS receiver 16 measures the current position at a predetermined time interval (for example, every second) and outputs the measurement result to the control unit 10. A representative example of a GNSS is the Global Positioning System (GPS).

The control unit 10 renders the map data stored in the storage unit 15 to display the map on the screen 13a of the display unit 13, acquires the current position measured by the GNSS receiver 16, and superimposes a mark indicating the vehicle position at the acquired current position, which is a position on a road on the map displayed on the screen 13a of the display unit 13 (map matching).

The DR sensor 17 includes various sensors such as a gyro sensor that measures the angular velocity related to the orientation of the vehicle in a horizontal plane, and a vehicle speed sensor that detects the rotational speeds of the left and right drive wheels of the vehicle.

The control unit 10 can also estimate the current position from the information acquired by the DR sensor 17. The control unit 10 may compare both the current position acquired by the GNSS receiver 16 and the current position estimated based on information acquired by the DR sensor 17, and then determine the final current position.

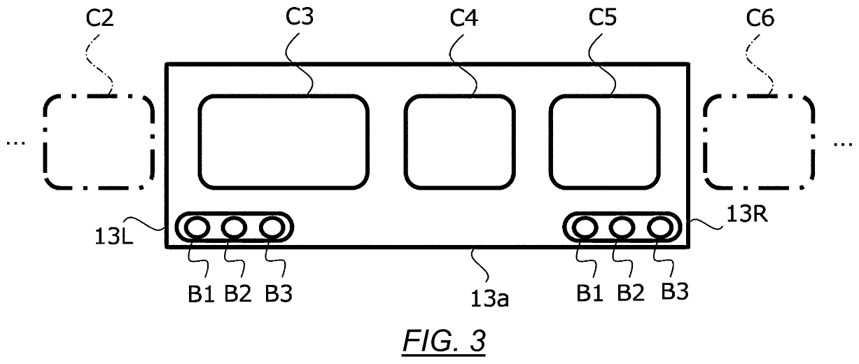

FIG. 3 depicts an example of a display screen displayed on the screen 13a of the display unit 13. On the screen 13a, for example, a portion of the plurality of objects arranged in virtual space are displayed. The virtual space is a two-dimensional virtual space or a three-dimensional virtual space.

The example of FIG. 3 displays objects C3 to C5 of the object group. The object group includes n number of objects C1 to Cn (n is a natural number). For convenience, a portion of the objects that are not displayed on the screen 13a are depicted by alternating long and short dash lines.

For example, when the control unit 10 detects a flick operation, the control unit updates the region in the virtual space displayed on the screen 13a in accordance with the detected flick operation. This causes the object to be scrolled on the screen 13a.

For example, when a flick operation is continued in the left direction of the screen, screen scrolling stops at the position where the rightmost object Cn is displayed. Furthermore, when a flick operation is continued in the right direction of the screen, screen scrolling stops at the position where the leftmost object C1 is displayed. Furthermore, the scrolling screen may cycle without stopping. For example, when a flick operation is performed to the right of the screen while objects C1 to C3 are displayed in order from the left of the screen, the screen 13a scrolls, and objects Cn, C1, and C2 are displayed in order from the left of the screen. For example, when a flick operation is performed to the left of the screen while objects Cn, C(n−1), and C(n−2) are displayed in that order from the right of the screen, the screen 13a scrolls and objects C1, Cn, and C(n−1) are displayed in that order from the right of the screen.

An object is a display on the screen 13a symbolizing an application type or information processed by the application, and is variable in shape and size. Examples include widgets, icons, thumbnail images, pop-ups, lists, and information display windows. A widget is a display object that includes interface components of a GUI (Graphical User Interface) and displays the results of processing by an application corresponding to that widget, and lays out a reception region for receiving instructions to be processed by that application. The object may be referred to by another name, such as content or the like.

The objects include, for example, objects that display information related to the navigation function, objects that display an overhead image of the vehicle when parking, objects for operating the audio functions installed in the in-vehicle system 1, objects for selecting radio stations, objects for adjusting the temperature and air volume of the air conditioner installed in the vehicle, and objects for displaying and setting various information related to the vehicle (for example, speedometer, tachometer).

In the example of FIG. 3, icons B1 to B3 are displayed close to the left edge 13L of the screen 13a (in other words, close to the driver seat S1). Icons B1 to B3 are also displayed close to the right edge 13R of the screen 13a (in other words, close to the passenger seat S2).

The icons B1 to B3 are operators associated with commands that have some effect on an object. For example, when an icon B1 for searching for a restaurant is dragged and dropped onto the map displayed in the route guidance object C5, the coordinate position of the restaurant on the map is highlighted. When the operator touches the highlighted coordinate position, the corresponding restaurant is set as the destination.

The icons B1 to B3 close to the left edge 13L are located close to the driver seat S1 and are difficult to reach from the passenger seat S2. Therefore, the icons B1 to B3 close to the left edge 13L can be referred to as an operating element for an operator (hereinafter referred to as the “driver”) seated in the driver seat S1. The icons B1 to B3 close to the right edge 13R are located close to the passenger seat S2 and are difficult to reach from the driver seat S1. Therefore, the icons B1 to B3 close to the right edge 13R can be referred to as operating elements for an operator (hereinafter referred to as the “passenger”) seated in the passenger seat S2. For convenience, the icons B1 to B3 close to the left edge 13L will be referred to as “driver icons B1 to B3”. The icons B1 to B3 close to the right edge 13R are designated as “passenger icons B1 to B3”.

In the example of FIG. 3, object C5 is located closer to the right edge 13R of the screen 13a. Therefore, it is difficult for the finger of the driver to reach object C5. Thus it is not easy for the driver to operate object C5. If the vehicle body vibrates while the vehicle is traveling, or if the object C5 requires precise operation, the difficulty of the operation further increases.

Therefore, for example, it is conceivable that the driver performs a flick operation to move object C5 toward the left edge 13L, and then operates object C5. In this case, the driver needs to perform an appropriate flick operation so that the object C5 moves to a position that is easy for the driver to operate. However, in a situation such as while driving, it is desirable to keep the time that the driver looks at the screen 13a short. Therefore, it is desirable to provide a user interface that does not require such a flick operation.

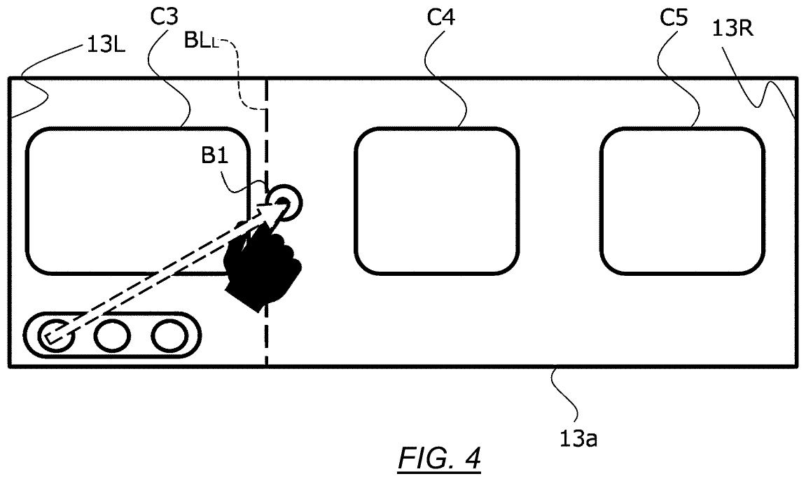

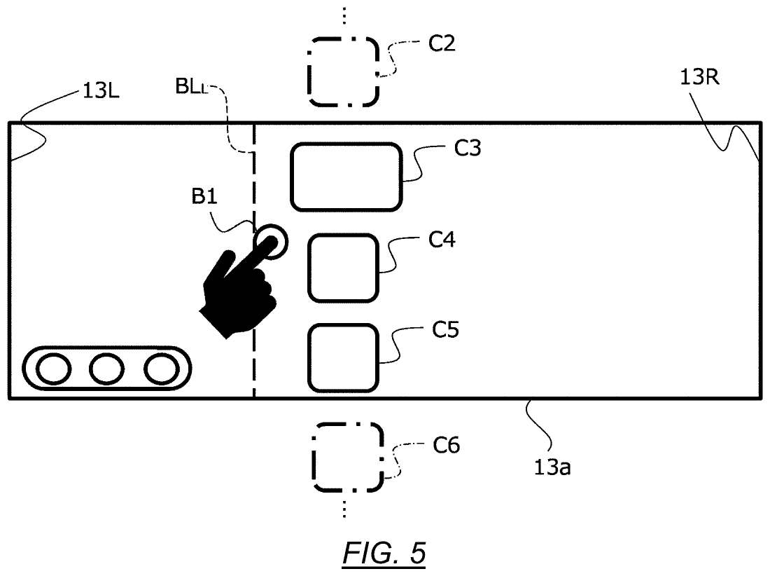

FIG. 4 and FIG. 5 depict examples of a display screen when a touch operation is performed on the screen 13a depicted in FIG. 3. The hand depicted in each of the figures depicting display screen examples including FIG. 4 indicates the manner in which the operator touches the screen 13a. Moreover, the outline arrow depicted by the dashed line indicates the movement of the finger of the operator performing a drag operation on the screen 13a.

In the example of FIG. 4, a state is depicted in which a driver icon B1 for searching for restaurants has been dragged to a position beyond the boundary line BL_{L}. The boundary line BL_{L} is located at a position that is easily reachable by a finger from the driver seat S1, and is slightly to the left of the center of the screen 13a.

When the driver icon B1 is dragged to a position beyond the boundary line BL_{L}, the objects displayed side by side in the horizontal direction of the screen are repositioned so as to be side by side in the vertical direction of the screen close to the boundary line BL_{L}, as depicted in FIG. 5, and are displayed on the screen 13a. In other words, the group of objects including object C5 that was displayed at a position that was difficult for a finger to reach is repositioned and displayed at a position that is easy for a finger to reach (here, close to the boundary line BL_{L}). A plurality of objects are displayed side by side in the vertical direction of the screen, so each object is displayed smaller than it was before the drag operation (see FIG. 3, for example).

By shrinking each object, more objects can be displayed in a limited space.

It should be noted that in the example of FIG. 5, when the driver drags the driver icon B1 to the vicinity of the upper end or the lower end of the screen and stops their finger at that position, the object is scrolled while the driver maintains their finger at that position. Thereby, the driver can display on the screen 13a objects (for example, object C2 and object C6) that were located outside the region of the screen 13a in the virtual space.

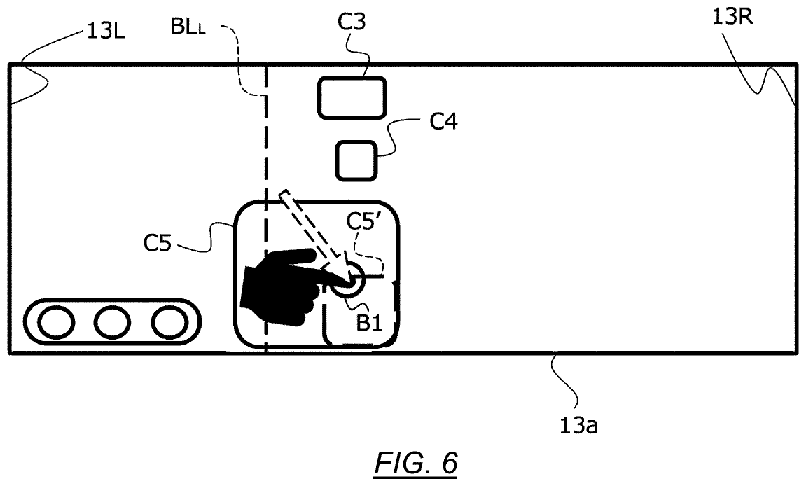

FIG. 6 depicts examples of a display screen when a touch operation is performed on the screen 13a depicted in FIG. 5. As depicted in FIG. 6, when the driver drags the driver icon B1 onto the object C5, the object C5 is displayed enlarged relative to the other objects. Note that in FIG. 6, for the sake of convenience, the object C5 before being enlarged is indicated by a dashed line and is denoted by the symbol C5′.

For example, object C5 returns to the original size before the drag operation (see FIG. 3, for example). In order to secure a display space for the enlarged object C5, the other objects are displayed in a reduced size at the same time as the object C5 is enlarged.

When the driver icon B1 is dragged out of the enlarged object C5, each object returns to the original size (see FIG. 5, for example). When the driver icon B1 is dragged onto, for example, object C4, object C4 is then displayed enlarged and the remaining objects are displayed with a reduced size.

In other words, the object at the dragged position of the driver icon B1 is displayed enlarged relative to the other objects.

By enlarging and displaying the object at the drag position, the operability of the object is improved.

When the driver icon B1 is dropped on the object C5, the coordinate position of the restaurant on the map displayed on the object C5 is highlighted. When the driver touches the highlighted coordinate location, the corresponding restaurant is set as the destination.

In the example of FIG. 3, object C3 is located toward the left edge 13L of the screen 13a. Therefore, it is difficult for a passenger sitting in the passenger seat S2 to reach object C3 with their finger. Hence, it is not easy for the passenger to operate object C3.

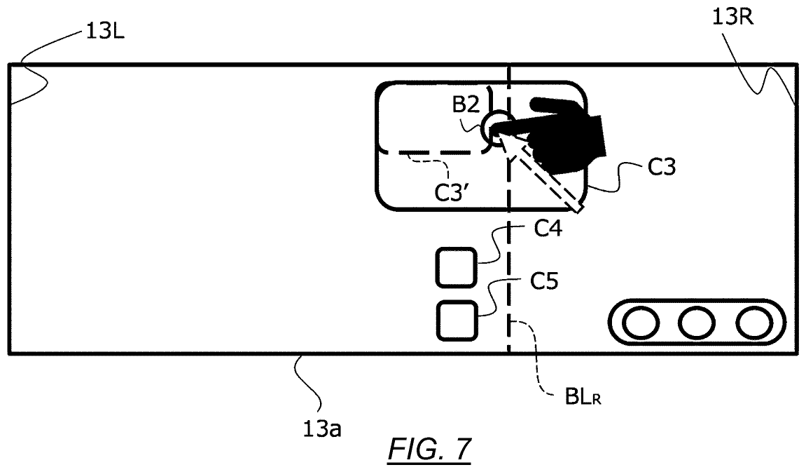

FIG. 7 is a diagram similar to FIG. 6, depicting an example of a display screen when the operator is a passenger. In the example of FIG. 7, the passenger icon B2 is dragged to a position beyond the boundary line BL_{R}, and the objects that were displayed side by side in the horizontal direction of the screen are repositioned so as to be side by side in the vertical direction of the screen close to the boundary line BL_{R}, and are displayed on the screen 13a. The boundary line BL_{R} is located at a position that is easily reachable by finger from the passenger seat S2, and is slightly to the right of the center of the screen 13a.

In this manner, the group of objects including object C3 that was displayed at a position that was difficult for a finger to reach is repositioned and displayed at a position that is easy for a finger to reach (here, close to the boundary line BL_{R}).

As depicted in FIG. 7, when the passenger further drags the passenger icon B1 onto the object C3, the object C3 is displayed enlarged relative to the other objects, similar to the example of FIG. 6. In FIG. 7, for the sake of convenience, the object C3 before being enlarged is indicated by a dashed line and is denoted by the reference character C3′.

In this manner, in the present embodiment, the objects that were displayed on the screen 13a are repositioned and displayed at a position closer to the operator (driver or passenger). This allows the operator to easily operate objects that were previously displayed in regions of the screen that were difficult to reach by the finger of the operator.

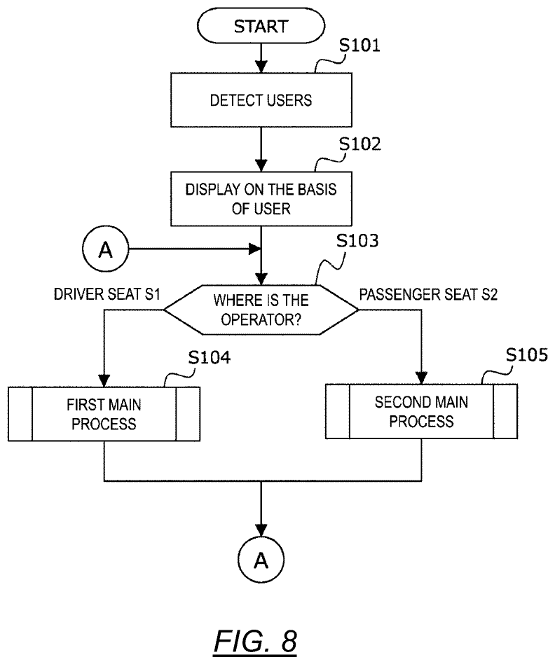

FIG. 8 is a flowchart depicting the processing of a computer program, such as the information processing program, executed by electronic processor 10 of information processing device 2 in an embodiment of the present disclosure. For example, when the in-vehicle system 1 is started, the execution of the process depicted in FIG. 8 is started. When the in-vehicle system 1 is shut down, the process depicted in FIG. 8 terminates.

Note that the order of steps in the flowchart depicted in the present embodiment may be changed as long as no inconsistencies are present. Furthermore, the steps of the flowchart depicted in the present embodiment may be executed in parallel or in parallel to the extent that there is no contradiction. For example, although the disclosure presents various steps of the process using an exemplary order, the process is not limited to the presented order.

The control unit 10 detects a user who uses an object (step S101).

For example, the control unit 10 displays a list of users. The user information included in the list is registered in advance by the user who is riding in vehicle A, for example. The control unit 10 detects the user selected by a touch operation from the list.

The control unit 10 displays an object corresponding to the user detected in step S101 on the screen 13a (step S102).

For example, the control unit 10 stores objects used by a user in association with that user. The control unit 10 determines the objects associated with the user detected in step S101 as the objects to be displayed on the screen 13a. The control unit 10 displays these objects on the screen 13a, and also displays the driver icons B1 to B3 and the passenger icons B1 to B3 close to the left edge 13L and the right edge 13R, respectively. This allows, for example, the screen depicted in FIG. 3 to be displayed.

In this manner, the control unit 10 operates as a setting unit that sets a user of an object from among a plurality of candidates (for example, users listed in a list), and also operates as a determination unit that determines the objects to be displayed on the screen 13a in accordance with the set user. The control unit 10 operates as a display control unit that displays the objects determined by the determination unit on the screen 13a.

The position and timing for displaying the icons B1 to B3 are not limited to those described above. For example, when the control unit 10 detects a long press operation (in other words, an operation of touching the screen 13a without moving a finger for at least a predetermined period of time), the control unit may display icons B1 to B3 at the position that is being long pressed.

An object associated with a user is, for example, an object that is frequently used by the user. The control unit 10 performs, for example, deep learning to associate users with objects.

The control unit 10 detects the position of the operator who touched the screen 13a (step S103). It should be noted that this operator is not necessarily the same as the user detected in step S101.

For example, when any of the driver icons B1 to B3 is touched, the control unit 10 detects that the operator is positioned in the driver seat S1. When any of the passenger icons B1 to B3 is touched, the control unit 10 detects that the operator is sitting in the passenger seat S2.

The control unit 10 may detect the position of the operator that touched the screen 13a using a driver monitoring system (DMS).

In this manner, the control unit 10 operates as a detection unit that detects the position of the operator relative to the screen 13a (an example of the screen of a display device). More specifically, the control unit 10 operating as a detection unit detects whether the operator is sitting in the driver seat S1 (an example of a left seat) or the passenger seat S2 (an example of a right seat). From another perspective, the control unit 10, operating as a detection unit, detects whether the operator is located close to the left edge 13L of the screen 13a (an example of a position close to the first edge of the screen) or close to the right edge 13R (an example of a position close to the second edge opposite the first edge).

When the operator is located in the driver seat S1 (in other words, when the operator is the driver) (step S103: driver seat S1), the control unit 10 executes a first main process (step S104). When the operator is located in the passenger seat S2 (for example, when the operator is a passenger) (step S103: passenger seat S2), the control unit 10 executes a second main process (step S105).

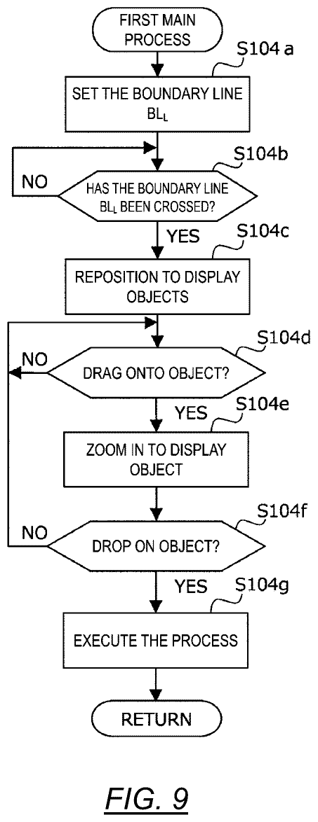

FIG. 9 depicts a subroutine of the first main process (step S104).

As depicted in FIG. 9, the control unit 10 sets a boundary line BL_{L} (step S104a).

In this manner, the control unit 10 operates as a boundary setting unit that sets a boundary line (here, boundary line BL_{L}) that divides the region within the screen 13a into a first region closer to the operator (here, the region to the left of the boundary line BL_{L} and closer to the driver) and a second region farther away from the operator (here, the region to the right of boundary line BL_{L} and closer to the passenger).

The control unit 10 determines whether or not the touched driver icon has been dragged to a position beyond the boundary line BL_{L} set in step S104a (step S104b).

If the driver icon is dragged to a position beyond the boundary line BL_{L} (step S104b: YES), the control unit 10 repositions the objects that were displayed side by side in the horizontal direction of the screen so that the objects are aligned in the vertical direction of the screen close to the boundary line BLL, as depicted in FIG. 5, for example, and displays the objects on the screen 13a (step S104c).

In this manner, the control unit 10 operates as a display control unit that repositions the operable objects displayed on the screen 13a so that the objects are closer to the position of the operator detected by the detection unit, and displays the objects on the screen 13a. Additionally, when the control unit 10 operating as a display control unit detects that the operator is located close to the left edge 13L of the screen 13a (an example of a position close to the first edge of the screen), the control unit repositions the objects closer to the left edge 13L and displays the objects on the screen 13a. In addition, when the control unit 10, operating as a display control unit, detects that the operator is located in the driver seat S1 (an example of the left seat), the control unit repositions the objects closer to the driver seat S1 and displays the objects on the screen 13a.

More specifically, the control unit 10 converts the arrangement of the objects in the virtual space from the horizontal direction of the screen to the vertical direction of the screen. The objects are arranged parallel to the boundary line BL_{L} at a predetermined distance from the boundary line BL_{L}. The control unit 10 reduces the size of each object and displays the objects on the screen 13a so that the objects that were displayed side by side in the horizontal direction of the screen can be displayed in the vertical direction of the screen.

In other words, when the control unit 10 operating as a display control unit detects a drag operation across the boundary line BL_{L} (an example of a drag operation from the first region to the second region), the control unit relocates the object close to the boundary line BL_{L} and displays the object on the screen 13a. More specifically, the control unit 10 operating as a display control unit repositions a plurality of objects so that the objects are aligned in a predetermined row close to the boundary line BL_{L} (specifically, so that the objects are aligned parallel to the boundary line BL_{L} at a position a predetermined distance away from the boundary line BL_{L}), and displays the objects on the screen 13a.

In this state, when a driver icon is dragged to the vicinity of the upper edge of the screen, the control unit 10 scrolls and displays the objects aligned vertically on the screen in the upward direction while the finger that performed the dragging operation remains in that position. Furthermore, when a driver icon is dragged to the vicinity of the lower edge of the screen, the control unit 10 scrolls and displays the objects aligned vertically on the screen in the downward direction while the finger that performed the dragging operation remains in that position.

If the driver icon is dropped without being dragged to a position beyond the boundary line BL_{L}, the control unit 10 ends the first main process (step S104). At this time, if the drop position is on an object (for example, on object C3), the control unit 10 executes a process for that object according to the driver icon.

The control unit 10 determines whether or not the driver icon has been dragged onto any of the objects aligned vertically on the screen (step S104d).

When the driver icon is dragged onto any object (step S104d: YES), the control unit 10 displays the object at the dragged position in an enlarged scale and displays the other objects in a reduced scale, as depicted in FIG. 6, for example (step S104e).

When the driver icon is dropped without being dragged onto any object, the control unit 10 ends the first main process (step S104) and returns to the screen display of FIG. 3, for example.

The control unit 10 determines whether or not the driver icon has been dropped onto the enlarged object (step S104f).

If the driver icon is dropped onto the enlarged object (step S104f: YES), the control unit 10 executes a process for the object according to the driver icon (step S104g).

When the user operation requested by the object on which the driver icon is dropped is completed, the control unit 10 ends the first main process (step S104) and returns to the screen display of FIG. 3, for example. If the process executed on the object resizes the object, the control unit 10 displays the object with the resized size.

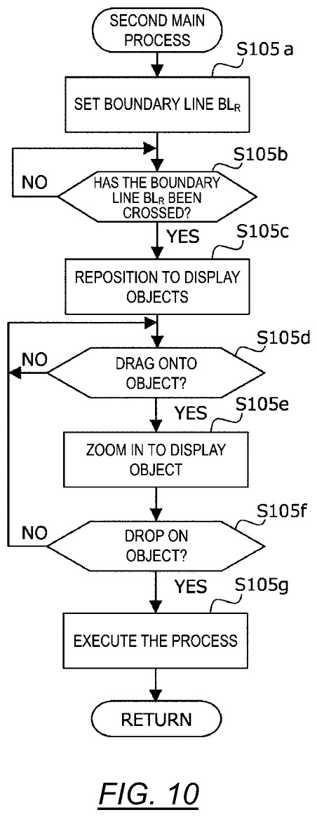

FIG. 10 depicts a subroutine of the second main process (step S105). As depicted in FIG. 10, the second main process (step S105) is basically the same as the first main process (step S104).

In the second main process (step S105), the operator is a passenger, so in step S105a, the control unit 10 sets the boundary line BL_{R} located closer to the passenger seat S2.

If the passenger icon is dragged to a position beyond the boundary line BL_{R} (step S105b: YES), the control unit 10 repositions the objects that were displayed side by side in the horizontal direction of the screen so that the objects are aligned in the vertical direction of the screen close to the boundary line BL_{R}, and displays the objects on the screen 13a (step S105c).

In this manner, when the control unit 10 operating as a display control unit detects that the operator is located close to the right edge 13R of the screen 13a (an example of a position close to the second edge of the screen), the control unit repositions the objects closer to the right edge 13R and displays the objects on the screen 13a. In addition, if the control unit 10, operating as a display control unit, detects that the operator is positioned in the passenger seat S2 (an example of a right-side seat), the control unit repositions the objects closer to the passenger seat S2 and displays the objects on the screen 13a.

When a passenger icon is dragged onto any object (step S105d: YES), the control unit 10 displays the object at the dragged position in an enlarged scale and displays the other objects in a reduced scale, as depicted in FIG. 7, for example (step S105e).

If the passenger icon is dropped onto the enlarged object (step S105f: YES), the control unit 10 executes a process for the object according to the driver icon (step S105g).

In this manner, in the present embodiment, the objects that were displayed on the screen 13a are repositioned and displayed at a position closer to the operator (driver or passenger). This allows the operator to easily operate objects that were previously displayed in regions of the screen that were difficult to reach by the finger of the operator.

The foregoing is a description of exemplary embodiments of the present disclosure. The embodiments of the present disclosure are not limited to those described above, and various modifications are possible within the scope of the technical gist of the present disclosure. For example, appropriate combinations of embodiments and the like that are explicitly indicated by way of example in the specification or obvious embodiments and the like are also included in the embodiments of the present application.

In the above embodiments, the objects are repositioned and displayed so as to be aligned vertically on the screen closer to the operator, but the manner in which the objects are repositioned is not limited to this case. The objects may be repositioned and displayed, for example, so as to be arranged in a circular pattern closer to the operator.

In the above embodiment, when an icon is dropped, the object is immediately enlarged and displayed, but the manner in which the object is enlarged is not limited to this case. When the icon is dropped, the object may, for example, move to the center of the screen and be displayed enlarged in the center of the screen.

### DESCRIPTION OF REFERENCE NUMERALS

1. In-vehicle system
2. Main unit
10. Control unit
11: Player
12. Sound system
13. Display unit
14: Operating unit
15. Storage unit
16: GNSS receiver
17. DR Sensor

1. An information processing device connected to a touch-operable display device, comprising:
a detection unit that detects a position of an operator with respect to a screen of the display device; and
a display control unit that repositions operable objects displayed on the screen so as to be closer to a position of the operator detected by the detection unit, and displays the objects on the screen.

2. The information processing device according to claim 1, wherein
the detection unit detects whether the operator is located closer to a first edge of the screen or closer to a second edge opposite to the first edge; and
the display control unit repositions the objects to be closer to the first edge and displays the objects on the screen when it is detected that the operator is located closer to the first edge of the screen, and the display control unit repositions the objects to be closer to the second edge and displays the objects on the screen when it is detected that the operator is located closer to the second edge of the screen.

3. The information processing device according to claim 1, wherein
the display device is installed in a vehicle;
a row of seats including a left seat and a right seat arranged in the same row is provided in the vehicle;
the screen is located in front of the row of seats and is formed to extend in a vehicle width direction of the vehicle;
the detection unit detects whether the operator is located in the left seat or located in the right seat; and
the display control unit repositions the objects to be closer to the left seat and displays the object on the screen when it is detected that the operator is located in the left seat, and the display control unit repositions the objects to be closer to the right seat and displays the object on the screen when it is detected that the operator is located in the right seat.

4. The information processing device according to claim 1, further comprising:
a setting unit for setting a user of the object from among a plurality of candidates; and
a determination unit that determines the objects to be displayed on the screen according to the set user;
wherein the display control unit displays the objects determined by the determination unit on the screen.

5. The information processing device according to claim 1, further comprising:
a boundary setting unit that sets a boundary line that divides a region in the screen into a first region closer to the operator and a second region farther from the operator, the boundary line being located closer to the operator;
wherein the display control unit repositions the objects close to the border and displays the objects on the screen when detecting a drag operation from the first region to the second region.

6. The information processing device according to claim 5, wherein the display control unit repositions the plurality of objects so as to be aligned in a predetermined row close to the boundary line, and displays the objects on the screen.

7. The information processing device according to claim 5, wherein the display control unit displays the objects selected by the touch operation in an enlarged manner relative to the other objects.

8. A non-transitory, computer-readable recording medium having stored thereon a computer program that, when executed by an electronic processor of an information processing device that is connected to a touch-operable display device, configures the information processing device to:
detect a position of an operator relative to a screen of the display device, and
execute a process of rearranging operable objects displayed on the screen so as to be closer to the detected position of the operator and display the objects on the screen.
